(19) United States
(12) Patent Application Publication
(10) Pub. No.: US 2011/0215719 A1
(43) Pub. Date: Sep. 8, 2011

(54) MANUFACTURING METHOD OF PLASMA DISPLAY PANEL, MAGNESIUM OXIDE CRYSTAL AND PLASMA DISPLAY PANEL

(75) Inventor: Tomonari Misawa, Yokohama (JP)

(73) Assignee: HITACHI, LTD.

(21) Appl. No.: 12/674,183

(22) PCT Filed: Sep. 21, 2007
(86) PCT No.: PCT/JP2007/068348

§ 371 Date: Feb. 19, 2010

(51) Int. Cl. H01J 17/49; H01J 9/00

(52) U.S. Cl. 313/586; 445/58

(57) ABSTRACT

A technology for PDP, etc. by which discharge delay improving effects can be enhanced over the prior art. In a representative embodiment, there is provided a process for manufacturing a PDP with a magnesium oxide (MgO) crystal layer (priming particle emitting layer) exposed in discharge space, the MgO crystal layer comprised of powder (grains) of MgO crystal, which process comprises performing thermal treatment of the MgO crystal in an oxygenous atmosphere. In particular, the thermal treatment is performed so that the lower limit of grain diameter of MgO crystal is 50 nm or greater.

### TECHNICAL FIELD

The present invention relates to a display device such as a plasma display panel (PDP), and more particularly to a priming particle emitting layer (electron emitting layer).

### BACKGROUND ART

The PDPs are becoming higher in resolution and the number of pixels therein is increasing. Therefore, the amount of time required for an address operation for selecting and determining the display cells to be lit or unlit is increasing. For suppressing this increase, the reduction of the pulse width of the voltage for address discharge (address voltage) is effective. However, the time from the application of the voltage to the generation of discharge (discharge delay) varies. Therefore, if the pulse width of the address voltage is too small, the discharge may not be generated even when the pulse is applied. In such a case, the aforementioned display cells are not appropriately lit in the sustain period, and thus, the degradation in image quality is caused.

As the means for improving the discharge delay in a PDP, a technology of providing an MgO crystal layer as a priming particle emitting layer (electron emitting layer) in a front substrate assembly has been known. This technology is disclosed in Japanese Patent Application Laid-Open Publication No. 2006-59786 (Patent Document 1).

The effect of improving the discharge delay by means of the MgO crystal layer described above increases as the particle size of the MgO crystal powder which makes up the layer becomes larger. For example, in Japanese Patent Application Laid-Open Publication No. 2006-147417 (Patent Document 2) discloses the technology for improving the average particle size by classifying the MgO crystal powder.
Patent Document 1: Japanese Patent Application Laid-Open Publication No. 2006-59786
Patent Document 2: Japanese Patent Application Laid-Open Publication No. 2006-147417

### DISCLOSURE OF THE INVENTION

### Problems to be Solved by the Invention

It is known in the technology disclosed in Patent Document 1 that the effect of improving the discharge delay can be observed when an idle period from the previous discharge to the address discharge is short, but the effect decreases when the idle period is long.

Furthermore, although the effect of improving the discharge delay increases as the particle size of the MgO crystal powder becomes larger as described above, since the amount of emission of the priming particle decreases as the idle period becomes longer, the discharge delay deteriorates (effect decreases) even in the technology of Patent Document 2. For achieving the high-contrast drive and the high-resolution drive, the further increase of the effect of improving the discharge delay is desired.

The present invention has been made in view of the problem as described above, and a main object of the present invention is to provide a technology for a PDP and others capable of increasing the effect of improving the discharge delay more than the conventional technologies.

### Means for Solving the Problems

The typical ones of the inventions disclosed in the present application will be briefly described as follows. For the achievement of the object described above, a typical embodiment of the present invention is a technology of providing an MgO crystal layer as a priming particle emitting layer (electron emitting layer) in a display device such as a PDP, and it is characterized by including a following structure.

A manufacturing method of a PDP (forming method of an MgO crystal layer) according to a typical embodiment is a manufacturing method of a PDP including an MgO crystal layer (priming particle emitting layer) exposed to a discharge space, wherein heat treatment is applied to an MgO crystal (powder), which makes up the MgO crystal layer, in an oxidation atmosphere (atmosphere containing oxygen). An MgO crystal layer with predetermined properties is formed on a target surface (protection layer, dielectric layer or others) by the use of the heat-treated MgO crystal. Further, as the heat treatment, the particle growth (crystal growth) of the MgO crystal (powder) is promoted by the predetermined heat treatment, so that the lower limit (minimum value) of the particle size in the particle size distribution of the MgO crystal powder of the MgO crystal layer is set to 50 nm or larger.

Furthermore, for promoting the particle growth more efficiently, flux (material having a function of lowering the melting point of the MgO (fusion agent)) may be added to the MgO crystal powder before the predetermined heat treatment. The MgO crystal layer is formed through the steps of disposing an MgO crystal containing material on a target surface by a coating method or a spray method, and removing unwanted components thereof by heating (heat treatment), thereby fixing the MgO crystal powder component.

Also, in the case where the flux is not added, for example, the MgO crystal powder is fired in the oxidation atmosphere at the temperature in the range from 1000 to 2800° C. (more strictly, 1300 to 2800° C.) for 0.1 to 48 hours (more strictly, 0.1 to 12 hours) as a firing process of the predetermined heat treatment. Further, in the case where flux is added, the MgO crystal powder is fired in the oxidation atmosphere at the temperature in the range from the melting point of the flux to 2800° C. for 0.1 to 12 hours as a firing process. By these means, the lower limit of the particle size of 50 nm or larger can be satisfied.

Also, the flux is halogen compound of magnesium (Mg). Particularly, the halogen compound is magnesium fluoride (MgF₂). More particularly, the halogen compound added as flux to the MgO crystal is 1 to 10000 ppm (weight concentration).

Also, the MgO crystal (MgO crystal powder) according to the typical embodiment is manufactured (formed) by using any of the above-described methods. Further, the PDP according to the typical embodiment is manufactured by using any of the above-described methods.

By means of the structure of the priming particle emitting layer (MgO crystal layer) as described above, the effect of improving the discharge delay continues for a long time. Even when the idle period from the previous discharge to the address discharge is long, the effect of improving the discharge delay can be obtained efficiently.

### Effects of the Invention

The effects obtained by typical embodiments of the present invention will be briefly described below. According to the typical embodiments of the present invention, the technology for PDP and others capable of increasing the effect of improving the discharge delay more than the conventional technologies can be provided. The details thereof will be described below.

In the MgO crystal (layer) of the present invention, the effect of improving the discharge delay continues for a long time due to the heat treatment in the oxidation atmosphere. The reason therefor is not always definite, but is supposed as follows. That is, it is supposed that the original electron (priming particle) emission properties of MgO are lost by the oxygen defect of MgO (MgO crystal) and the oxygen defect can be suppressed by the heat treatment in the oxidation atmosphere (thereby exerting the original electron emission properties).

Furthermore, with respect to the MgO crystal (layer), a predetermined heat treatment is carried out so as to promote the particle growth. By this means, the particle with the particle size of smaller than 50 nm whose effect of improving the discharge delay is small can be eliminated, and the particle with a larger particle size than the particle before the heat treatment can be manufactured (formed).

In the method of Patent Document 2 described above (classification or others), the complete removal of the particle with the small particle size by the treatment is difficult, and the particle with the particles size larger than that of the particle before the treatment cannot be obtained. Therefore, the effect larger than that of the method of Patent Document 2 can be obtained in the method of the present invention.

Furthermore, when flux is added to the MgO crystal of the present invention before the heat treatment, the particle can be grown more efficiently with lower heat-treatment energy. In other words, the manufacturing efficiency can be improved.

### BRIEF DESCRIPTIONS OF THE DRAWINGS

FIG. 1 is an exploded perspective view showing the principal part of an example of a basic structure of a PDP according to an embodiment of the present invention in an enlarged manner;

FIG. 2 is a diagram showing an example of a cross-sectional structure of a front substrate assembly including an MgO crystal layer (priming particle emitting layer) in the PDP according an embodiment of the present invention;

FIG. 3 is an explanatory diagram showing a manufacturing flow of the MgO crystal and the MgO crystal layer according to an embodiment of the present invention;

FIG. 4 shows MgO crystal layers observed by SEM (Scanning Electron Microscope) in an MgO crystal, an MgO crystal layer and a manufacturing method of a PDP according to a first embodiment of the present invention, in which FIG. 4A shows the MgO crystal layer formed by the process of the first embodiment, FIG. 4B shows the MgO crystal layer formed by the process in an atmosphere containing no oxygen, and FIG. 4C shows the MgO crystal layer fabricated without the heat treatment like in the conventional technologies;

FIG. 5 is a graph showing dependency of discharge delay of the PDP using the MgO crystal layer (MgO crystal) with respect to an idle period in relation to FIG. 4 according to the first embodiment of the present invention;

FIG. 6 is a diagram showing an MgO crystal layer observed by SEM in an MgO crystal, an MgO crystal layer and a manufacturing method of a PDP according to a second embodiment of the present invention;

FIG. 7 is a graph showing dependency of discharge delay of the PDP using the MgO crystal layer (MgO crystal) with respect to an idle period in relation to FIG. 6 according to the second embodiment of the present invention; and

FIG. 8 is a diagram showing voltage waveforms for measurement used for the test of (improvement effect of) the discharge delay of the PDP having the priming particle emitting layer (MgO crystal layer) according to an embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<Outline>

In a PDP, an MgO crystal (layer) and a manufacturing method thereof according to a present embodiment, the MgO crystal is heat-treated in an oxidation atmosphere. The conditions of the heat treatment are as follows. That is, the oxygen concentration of the oxidation atmosphere is 1 to 100% and the temperature thereof is in the range from 500 to 2800° C. Also, in the case of the structure where the particle growth (crystal growth) is promoted, the temperature is in the range from 1000 to 2800° C. Also, in the case of the structure where flux is added to the MgO crystal (powder), the temperature is in the range from the melting point of the flux to 2800° C.

In the case of the structure where the flux is added, the type of the flux is not particularly limited as long as the flux has a function of lowering the melting point of MgO (MgO crystal). The flux is, for example, compound containing a halogen element, compound containing Al (aluminum) or Ti (titanium), and others. In particular, the use of magnesium fluoride (MgF₂) is preferable. The amount of flux to be added is 1 to 10000 ppm.

In the particle size distribution of the MgO crystal after the heat treatment, the lower limit (minimum value) of the particle size is desirably 0.05 μm (50 nm) or larger and the upper limit (maximum value) thereof is desirably 20 μm or smaller.

<PDP (Basic Structure)>

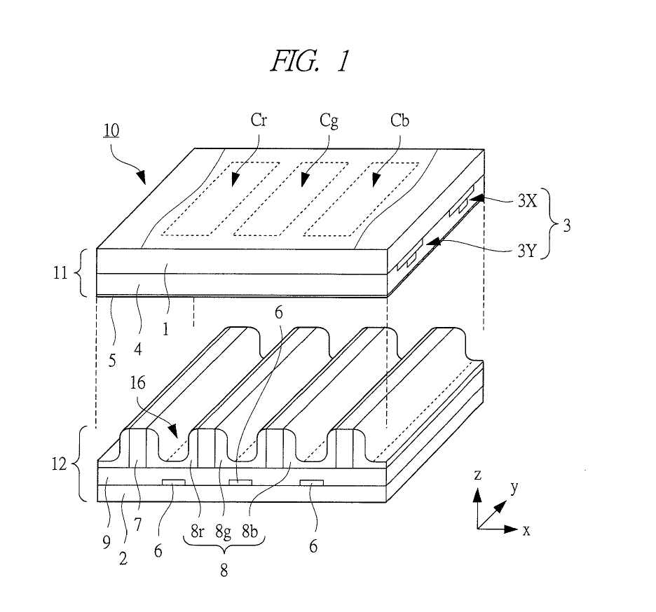

FIG. 1 shows an example of a basic structure of a PDP (panel) 10 according to the present embodiment. This example shows a set of display cells (Cr, Cg and Cb) corresponding to a pixel. Note that an x direction (first direction, lateral direction), a y direction (second direction, longitudinal direction) and a z direction (third direction, direction vertical to panel surface) are provided for description.

The PDP 10 is formed by combining a front substrate assembly 11 and a rear substrate assembly 12, and has discharge spaces 16 therebetween. In the front substrate assembly 11, a group of display electrodes 3 (3X, 3Y) is disposed in the x direction on a front glass substrate 1. The display electrode 3 includes a sustain electrode 3X for sustain operation and a scan electrode 3Y for (both of) sustain operation and scan operation. The display electrode 3 (3X, 3Y) is made up of, for example, a transparent electrode and a bus electrode. On the front glass substrate 1, the group of display electrodes 3 is covered with a dielectric layer 4. A protection layer 5 is formed further on the dielectric layer 4. The dielectric layer 4 and the protection layer 5 are formed on the entire surface corresponding to the display region (screen) of the PDP 10.

In the rear substrate assembly 12, a group of address electrodes 6 is disposed on a rear glass substrate 2 in the y direction intersecting the display electrode 3. The group of address electrodes 6 is covered with a dielectric layer 9. Barrier ribs 7 are formed between the address electrodes 6 in, for example, the y direction on the dielectric layer 9. The barrier ribs 7 form the discharge spaces 16 partitioned so as to correspond to unit light-emission regions (display cells). Above the address electrodes 6, in the regions partitioned by the barrier ribs 7, phosphors (phosphor layers) 8 (8r, 8g, 8b) for the colors of R (red), G (green) and B (blue) are respectively formed in respective columns in order.

In an inner region formed by bonding the front substrate assembly 11 and the rear substrate assembly 12 together, discharge gas (for example, gas obtained by mixing about several % of Xe with Ne) is filled, thereby forming gastight discharge spaces 16. Outer edges of the PDP 10 are bonded by a sealing material. The display cells are formed so as to correspond to the intersecting portions of the sustain electrodes 3X, the scan electrodes 3Y and the address electrodes 6.

In the drive of the PDP 10 (subfield method or address display separated method), discharge (address discharge) is generated by applying voltage between the address electrode 6 and the scan electrode 3Y in the display cell to be selected (address operation period). Also, for the selected display cells, discharge (sustain discharge (display discharge) or the like) is generated by applying voltage between the pair of the display electrodes 3 (3X, 3Y) (sustain operation period). In this manner, the light emission (lighting) of subfields in the desired display cells is carried out. Also, by selecting subfields to be lit in a field, the luminance of the pixel (display cell) is expressed.

<PDP (Detailed Structure)>

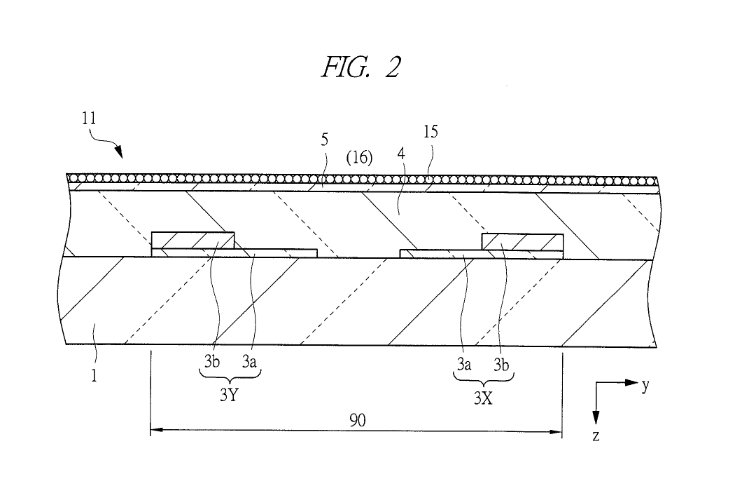

In FIG. 2, on a surface of the protection layer 5 in the front substrate assembly 11 of the PDP 10 of the present embodiment, a priming particle emitting layer (referred to as P layer) 15 is formed so as to be exposed to the discharge space 16. The P layer 15 is an MgO crystal layer containing an MgO crystal powder. Alternatively, the P layer 15 contains an MgO crystal powder to which a halogen element such as fluorine (F) is added. Note that, in the P layer 15, the MgO crystal powder is distributed densely or sparsely onto the target surface (protection layer 5) (referred to as layer (film) even when the MgO crystal powder is distributed sparsely).

A transparent material such as glass can be used for the front glass substrate 1. The display electrode 3 can be made up of, for example, a transparent electrode 3a which is made of ITO and has a large width to form a discharge gap and a bus electrode 3b which is made of metal such as Cu or Cr and has a small width to lower electrode resistance. The electrode shape is not particularly limited, but for example, the transparent electrode 3a has a plate shape or a T-shape for each display cell, and the bus electrode 3b has a linear shape. In the display electrodes 3, display lines are provided by the pairs of the adjacent sustain electrode 3× and scan electrode 3Y. As the electrode arrangement configuration, the normal configuration in which a pair of discharge electrodes 3 to be a non-discharge region (reverse slit) is provided and the so-called ALIS configuration in which the display electrodes 3 (3X, 3Y) are alternately disposed at regular intervals and display lines are formed by all the adjacent pairs of display electrodes 3 are possible.

The dielectric layer 4 is formed by, for example, coating a low-melting-point glass paste on the front glass substrate 1 by a screen printing method and then firing the paste. The protection layer 5 has a function of protecting the dielectric layer 4, emitting secondary electrons and others. The protection layer 5 is made of metal oxide such as MgO, calcium oxide, strontium oxide or barium oxide, and is preferably made of an MgO layer having high secondary electron emission coefficient. The protection layer 5 is formed by, for example, the electron beam evaporation method (sputtering method, coating method or the like).

The rear substrate assembly 12 is fabricated by using the conventional technology in the following manner. The rear glass substrate 2, the address electrode 6, the dielectric layer 9 and others can be fabricated in the same manner as those of the front substrate assembly 11. The barrier ribs 7 can be formed by forming a layer made of a material such as low-melting-point glass paste and then patterning and firing the paste by a method such as sandblast. The barrier ribs 7 may have a stripe shape extending only in the y direction or a box shape including barrier rib portions in the x and y directions. The phosphors 8 are formed by coating phosphor paste for each color of R, G and B to the regions between the barrier ribs 7 by the screen printing method or the dispenser method and then firing the paste.

<Priming Particle Emitting Layer (MgO Crystal Layer)>

The P layer (MgO crystal layer) 15 is disposed at any place exposed to the discharge space in the substrate assembly which makes up the PDP 10. For example, the P layer 15 may be directly disposed on the dielectric layer 4, or the P layer 15 may be disposed on the protection layer 5 on the dielectric layer 4. In the structure of the present embodiment, the P layer 15 is disposed on the protection layer 5 in the front substrate assembly 11 as shown in FIG. 2. Since the P layer 15 is disposed so as to be exposed to the discharge space 16, the function of emitting priming particles to the discharge space 16 and the effect of improving the discharge delay in the PDP 10 can be achieved by the P layer 15 (MgO crystal powder which makes up the P layer 15).

The P layer 15 is made of a priming particle emitting powder material. The priming particle emitting powder material includes an MgO crystal powder or an MgO crystal powder to which a halogen element is added.

The halogen element to be added is made of one or two or more of fluorine (F), chlorine, bromine and iodine. It is confirmed that the effect of improving the discharge delay continues for a long time when fluorine is used. The amount of the halogen element to be added is, for example, 1 to 10000 ppm. The material containing halogen element includes, for example, magnesium fluoride (MgF₂) which is halide of Mg and halide of Al, Li, Mn, Zn, Ca and Ce.

The firing of the material containing MgO crystal powder is conducted in the temperature range of, for example, 1000 to 1700° C. The MgO crystal or the MgO crystal to which a halogen element is added is preferably in a powder state and has a particle size in the above-described predetermined range (50 nm to 20 μm). In particular, the lower limit (minimum value) of the particle size is preferably equal to or larger than the predetermined size (50 nm or larger). When the particle size is too small, the effect of improving the discharge delay by the P layer 15 is reduced. In contrast, when the particle size is too large, it is difficult to evenly form the P layer 15.

The MgO crystal has properties of performing the CL (Cathode Luminescence) light emission having a peak within a specific wavelength range of 200 to 300 nm by the irradiation of electron beam. In the manufacturing method of the MgO crystal, the gas phase method in which Mg vapor and oxygen are reacted with each other is preferably used. The high-purity single crystal can be obtained by using the gas phase method.

The forming method of the P layer 15 is basically as follows. That is, a material in a state of paste or slurry (material containing priming particle emitting powder) obtained by mixing and dispersing the MgO crystal powder in a powder state into solvent (solvent medium) is prepared. Then, this material is sprayed (diffused) or coated onto a target surface, thereby forming a film. For example, the method of spraying slurry or the method of paste coating by the printing can be used. Further, the material formed into a film is dried and fired to remove the solvent component and others and fix the powder component to the target surface, so that the P layer 15 is completed. For example, the P layer 15 is formed on the entire surface of the target surface (surface of protection layer 5) so as to have a predetermined thickness.

### First Embodiment

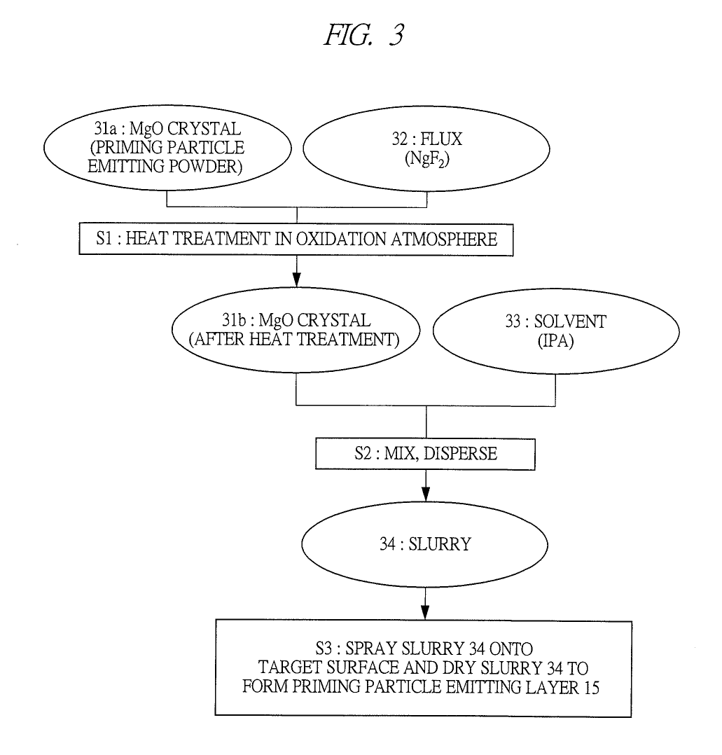

The MgO crystal (31b), the PDP 10 having the P layer 15 made of the MgO crystal and others according to a first embodiment of the present invention will be described with reference to FIG. 3 to FIG. 5 and others. The structure of the first embodiment is as follows.

FIG. 3 shows the manufacturing flow of the MgO crystal (31b) and the MgO crystal layer (P layer) 15 (note that the addition of flux 32 is unnecessary in the first embodiment). As the MgO crystal 31a (priming particle emitting powder) to be a material before the heat treatment, Product Name: High Purity & Ultrafine Single Crystal Magnesia Powder (2000A) produced by Ube Material Industries, Ltd. is used. To this MgO crystal 31a, heat treatment is applied in an oxidation atmosphere containing nitrogen (N) and oxygen (O) at a ratio of 4:1 at 1450° C. for 4 hours (step S1). In this manner, the MgO crystal 31b after the heat treatment is produced.

The MgO crystal 31b after the heat treatment is mixed into IPA (isopropyl alcohol) serving as solvent 33 at a ratio of 2 gram per 1 liter (2 g/L) and dispersed by the ultrasonic disperser (step S2). By this means, the slurry 34 is produced.

The slurry 34 is sprayed (diffused) by the use of painting spray gun or the like or coated onto the surface of the protection layer 5 (target surface) of the front substrate assembly 11 on which the protection layer 5 (MgO layer) has been already formed by evaporation, thereby forming the layer (film). Then, the layer (slurry 34) is dried by applying heat (removal of solvent component and others), so that the P layer 15 is completed (step S3). The amount of slurry 34 to be formed (applied) is 2 g/m².

By using the front substrate assembly 11 on which the P layer 15 has been formed in the above-described manner, the PDP 10 is fabricated.

By the heat treatment (S1) of the first embodiment, the particle growth (crystal growth) of the MgO crystal 31a is promoted. More specifically, the particle with a large particle size is produced through the melting and bonding of the particles themselves. As a result, the lower limit (minimum value) of the particle size in the particle size distribution of the MgO crystal 31b of the P layer 15 is set to 50 nm or larger (almost all of the powders with a particle size of smaller than 50 nm are eliminated).

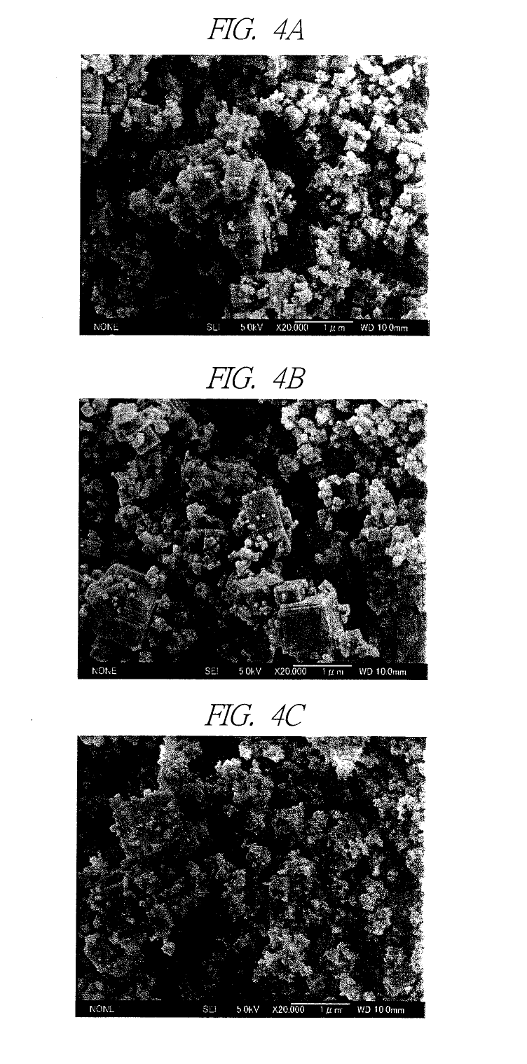

FIG. 4 shows the MgO crystal layer 15 produced by the method described above and observed by SEM (Scanning Electron Microscope).

FIG. 4A shows the MgO crystal layer 15. For comparison, FIG. 4B shows the layer produced through the same process as that of FIG. 4A other than that the heat treatment (step S1) is carried out in an atmosphere containing nitrogen (N) and oxygen (O) at a ratio of 1:0, that is, in an atmosphere containing no oxygen (nitrogen atmosphere). Also, FIG. 4C shows the layer produced without the heat treatment (step S1) like the conventional technology.

In the MgO crystal layers to which the heat treatment is applied, as shown in FIG. 4A and FIG. 4B, the minimum particle size is increased regardless of the difference in the atmosphere compared with the layer of the conventional technology in FIG. 4C to which the heat treatment is not applied. In other words, the lower limit of the particle size is increased compared with that before the heat treatment.

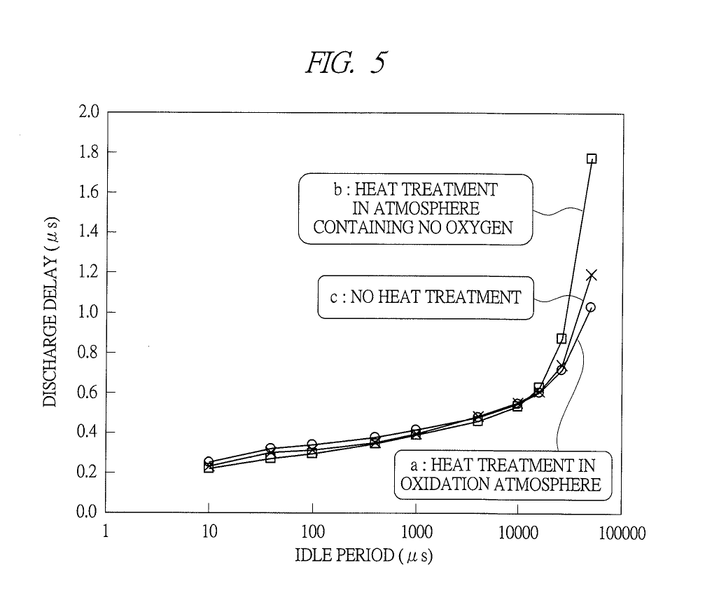

As a graph in relation to FIG. 4, FIG. 5 shows dependency of discharge delay ([μs]) of the PDP 10 using the MgO crystal layer 15 (MgO crystal 31b) with respect to an idle period ([μs]). The graph a shows the properties of the product using the layer processed in the oxidation atmosphere (MgO crystal 31b and MgO crystal layer 15) corresponding to FIG. 4A. The graph b shows the properties of the product using the layer processed in the atmosphere containing no oxygen corresponding to FIG. 4B. The graph c shows the properties of the product using the layer to which no heat treatment is applied (MgO crystal layer to which no heat treatment is applied) corresponding to FIG. 4C.

In the product using the layer processed in the oxidation atmosphere shown by the graph a, the effect of improving the discharge delay can be observed (particularly in the case of long idle period) compared with the product using the layer to which no heat treatment is applied shown by the graph c. On the other hand, in the product using the layer processed in the atmosphere containing no oxygen shown by the graph b, the properties (effect) of the discharge delay are deteriorated (particularly in the case of long idle period). These results indicate the effect obtained by the process in the oxidation atmosphere shown by the graph a according to the present embodiment.

### Second Embodiment

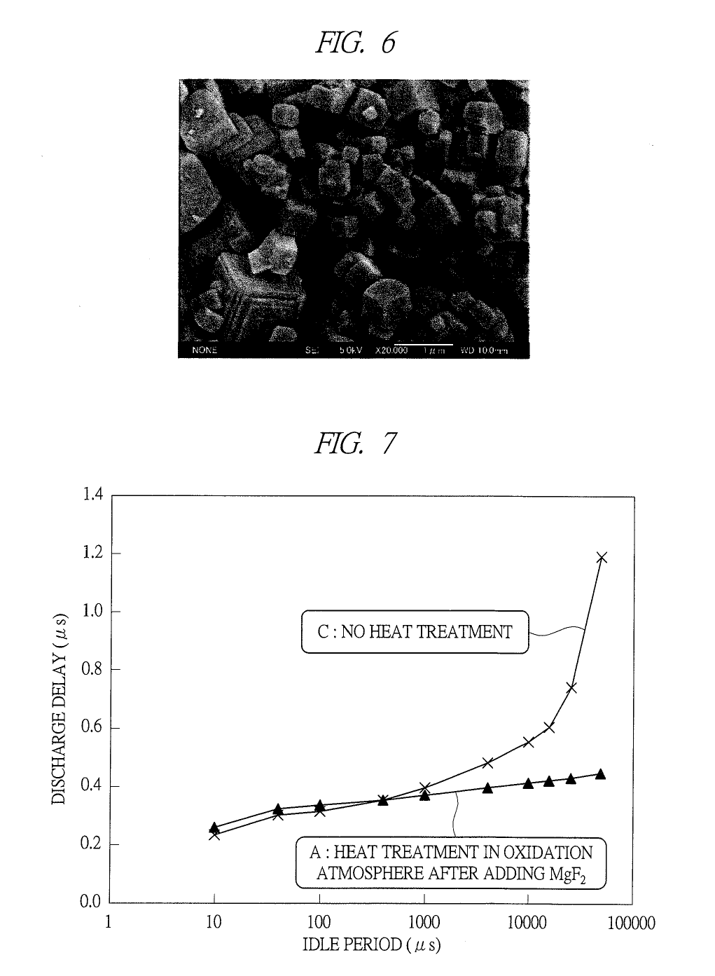

Next, the MgO crystal (31b), the PDP 10 having the P layer 15 and others according to a second embodiment of the present invention will be described with reference to FIG. 6 and FIG. 7 and others. The structure of the second embodiment is as follows.

In FIG. 3 (addition of flux is required in the second embodiment), as materials before the heat treatment, the MgO crystal 31a similar to the first embodiment (High Purity & Ultrafine Single Crystal Magnesia Powder (2000A)) and magnesium fluoride (MgF₂) (purity: 99.99%) produced by Furuuchi Chemical Corporation as the flux 32 to be added thereto are used in the second embodiment. These materials (31a and 32) are weighed so that MgO and MgF₂ have a ratio (molar ratio) of 1:0.0001 and are mixed by using a tumbler mixer. To the mixed powder, heat treatment is applied in an oxidation atmosphere containing nitrogen (N) and oxygen (O) at a ratio of 4:1 at 1450° C. for 4 hours (step S1). In this manner, the MgO crystal 31b after the heat treatment is produced. Note that, because of the addition of the flux 32, this MgO crystal 31b is different from the MgO crystal 31b produced in the first embodiment.

Since the powder (31b) processed as described above contains powders in an aggregated state, the aggregated powders are ground with a mortar and pestle (aggregated powders are put in a mortar and brayed with a pestle) so as to obtain the powder having a uniform particle size. Thereafter, the front substrate assembly 11 having the P layer 15 and the PDP 10 are fabricated through the same steps (S2, S3) as the first embodiment.

FIG. 6 shows the MgO crystal layer 15 produced by the method described above and observed by SEM. As shown in FIG. 6, in the MgO crystal (31b) powder of the MgO crystal layer 15, the minimum particle size is increased even compared with FIG. 4, and the lower limit of the particle size in the particle size distribution is 50 nm (0.05 μm) or larger.

As a graph in relation to FIG. 6, FIG. 7 shows dependency of discharge delay of the PDP 10 using the MgO crystal layer 15 (MgO crystal 31b) with respect to an idle period. The graph A shows the properties of the product using the layer processed in the oxidation atmosphere after adding MgF₂ (MgO crystal 31b and MgO crystal layer 15) corresponding to FIG. 6. The graph C shows the properties of the product using the layer to which no heat treatment is applied (MgO crystal layer to which no heat treatment is applied) similar to that of FIG. 4C.

As is apparent from FIG. 7, the discharge delay can be significantly improved in the product shown by the graph A compared with the product shown by the graph C (particularly in the case of long idle period).

As described above, according to the first and second embodiments, the effect of improving the discharge delay is enhanced by increasing the particle size of the MgO crystal (31b).

<Discharge Delay>

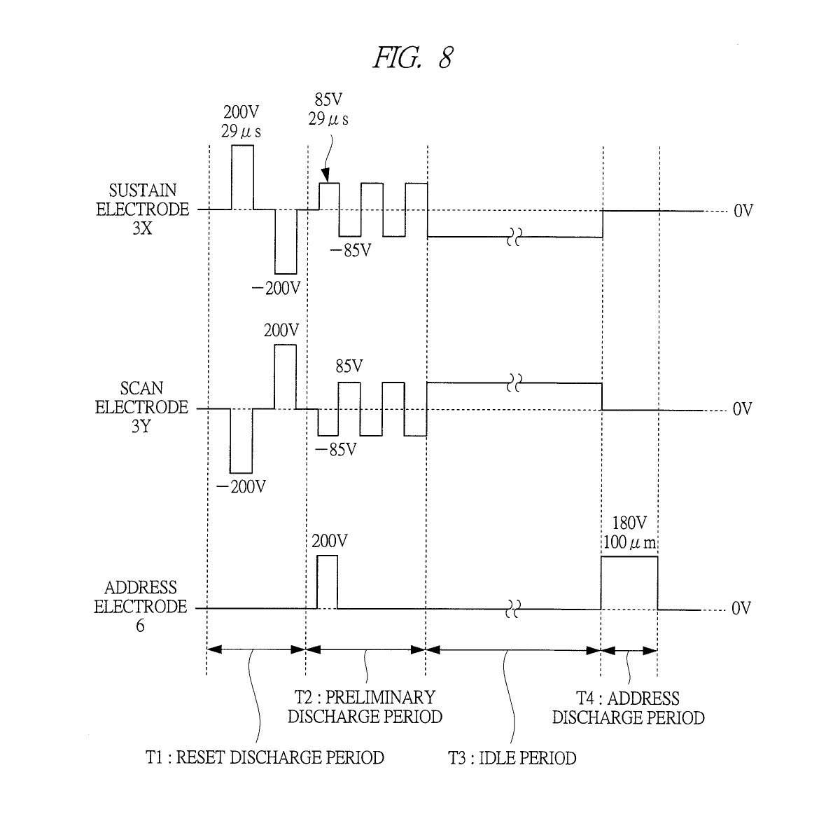

FIG. 8 supplementarily shows voltage waveforms for measurement used for the test of (improvement effect of) the discharge delay of the PDP 10 having the P layer (MgO crystal layer) 15. By applying these voltage waveforms to the electrodes (3X, 3Y, 6) of the display cell, the effect of improving the discharge delay can be tested.

In the reset discharge period (T1), the charge state is reset by generating the reset discharge between the sustain electrode 3X and the scan electrode 3Y. In the preliminary discharge period (T2), after specific display cells are selected, discharge is generated between the sustain electrode 3× and the scan electrode 3Y to excite the powder of the P layer 15. Thereafter, after the idle period (T3), a voltage is applied to the address electrode 6 in the address discharge period (T4). The time from the application of the voltage to the start of actual discharge is measured. The shorter this time (delay) is, the more favorable the properties are.

The effect of improving the discharge delay by the P layer 15 increases as the particle size of the MgO crystal powder becomes larger. However, when the idle period (T3) becomes long, the discharge delay is deteriorated because the amount of priming particle emission decreases.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention can be applied to a display device such as a PDP.

1. A manufacturing method of a plasma display panel comprising a magnesium oxide (MgO) crystal layer exposed to a discharge space, wherein
the MgO crystal layer contains powder of an MgO crystal, and
heat treatment in an oxidation atmosphere containing oxygen is applied to the powder of the MgO crystal.

2. The manufacturing method of the plasma display panel according to claim 1, wherein
the heat treatment is applied so that a lower limit of a particle size in a particle size distribution of the MgO crystal in the MgO crystal layer becomes 50 nm or larger.

3. The manufacturing method of the plasma display panel according to claim 2, wherein
firing is conducted at a temperature in a range from 1000 to 2800° C. for 0.1 to 48 hours in the heat treatment.

4. The manufacturing method of the plasma display panel according to claim 2, wherein
flux having a function of lowering a melting point of the MgO is added to the powder of the MgO crystal before the heat treatment, and then, the heat treatment is applied to the powder of the MgO crystal.

5. The manufacturing method of the plasma display panel according to claim 4, wherein
firing is conducted at a temperature in a range from a melting point of the flux to 2800° C. for 0.1 to 12 hours in the heat treatment.

6. The manufacturing method of the plasma display panel according to claim 4, wherein
the flux is halogen compound of magnesium.

7. The manufacturing method of the plasma display panel according to claim 6, wherein
the halogen compound is magnesium fluoride (MgF₂).

8. The manufacturing method of the plasma display panel according to claim 3, wherein
an MgO crystal containing material obtained by dispersing the MgO crystal after the heat treatment into solvent is disposed to form a layer on a dielectric layer or a protection layer on the dielectric layer of the plasma display panel, and then heat is applied to remove the solvent component, thereby forming the MgO crystal layer.

9. The manufacturing method of the plasma display panel according to claim 5, wherein
an MgO crystal containing material obtained by dispersing the MgO crystal after the heat treatment into solvent is disposed to form a layer on a dielectric layer or a protection layer on the dielectric layer of the plasma display panel, and then heat is applied to remove the solvent component, thereby forming the MgO crystal layer.

10. An MgO crystal which makes up a magnesium oxide (MgO) crystal layer exposed to a discharge space in a plasma display panel, wherein
heat treatment in an atmosphere containing oxygen is applied to powder of the MgO crystal, so that a lower limit of a particle size in a particle size distribution becomes 50 nm or larger.

11. A plasma display panel comprising a magnesium oxide (MgO) crystal layer exposed to a discharge space, wherein
the MgO crystal layer contains powder of an MgO crystal,
heat treatment in an atmosphere containing oxygen is applied to the powder of the MgO crystal, so that a lower limit of a particle size in a particle size distribution becomes 50 nm or larger, and
the MgO crystal layer containing the powder of the MgO crystal to which the heat treatment is applied is formed on a dielectric layer or a protection layer on the dielectric layer of the plasma display panel.
